(19) United States
(12) Patent Application Publication
(10) Pub. No.: US 2013/0319286 A1
(43) Pub. Date: Dec. 5, 2013

(54) METHOD FOR THE TREATMENT OF WOOD BY SILICATE BORATE PAIRING

(71) Applicant: Pierre Herve, St Hilaire le Chat (FR)

(72) Inventor: Pierre Herve, St Hilaire le Chat (FR)

(21) Appl. No.: 13/138,157

(22) PCT Filed: May 11, 2011
(86) PCT No.: PCT/FR11/00288

§ 371 Date: Jul. 14, 2011

(30) Foreign Application Priority Data
Feb. 21, 2011 (FR) 1100508

(51) Int. Cl. C09D 5/14; C09D 5/18

(52) U.S. Cl. CPC C09D 5/14; C09D 5/18
USPC 106/18.12

(57) ABSTRACT

The present invention relates to a method of treatment particularly intended for exterior wood for preventative and remedial protection against wood-destroying agents and against fire propagation, characterised in that it involves the application of a mixture with a dose of 4.55% disodium octoboratetetrahydrate combined with a dose of 0.75% sodium or potassium silicate, a plagioclase adjuvant, basalt and pyroxene powder content 0.005%, sunlight protection through zinc oxide or titanium oxide in a proportion of 0.1%.

The present invention relates to a method for the treatment of wood and its associated wood treatment products by so-called borate/silicate pairing. The invention is likewise suitable for porous materials, building carcass products and rust.

### BACKGROUND OF THE INVENTION

Several wood treatment products are known that are intended to penetrate the core of the wood and offer protection against external attack (fungus, termites, insects). The treatment products are well-known and include, for example, fungicides or insecticides. These products aim to modify and improve the resistance of wood. They can offer fire resistance. In a very large number of industrial applications, it is essential for wood to be treated in advance before it enters the public domain. A major fault in the use of these products lies in the fact that their use and recycling are polluting.

### BRIEF DESCRIPTION OF THE INVENTION

A main object of the invention is to propose a non-polluting method for the treatment of wood.

Another main object of the invention is to propose a treatment product that helps to improve the wood's characteristics. The invention aims particularly to promote so-called low-quality species by reinforcing their resistance status and mechanical modification. This mechanical resistance is, for example, what is sought-after when there are changes in humidity that produce play in the structure of the wood.

The invention therefore aims to propose an ecological wood treatment product that likewise reinforces the wood's mechanical resistance properties. The invention exhibits hardening properties with a solidification of porous and fibrous materials (wood, wall, fibres, etc.) mineralisation by solidification: hardens the materials and makes them less friable.

An object of the invention is to reinforce the initial fire resistance, in other words, to slow down the fire propagation on the wood when it is treated with the present invention. The invention must, in particular, satisfy the fire-resistance restrictions according to the NF EN 13501 standards (propagation: 30 minutes, penetration: 21 minutes), this being for shingle roofs.

An object of the invention is to propose a fungicide, insecticide and anti-termite treatment. The invention guarantees protection for all types of wood implemented in the relevant risk category uses 1, 2 and 3.

An object of the invention is to propose a method for the treatment of wood that does not fade and therefore properly satisfies the restrictions on the exterior use of wood exposed to sunlight and changes in humidity. The invention prevents water penetration and makes materials less porous. It increases the resistance of the base and slows down ageing.

An object of the invention is that the product satisfies the properties mentioned below for facades, walls and rust. The product is able to provide deep penetration. It is suitable for use on new and old materials. It eliminates chalking of coatings, pebble-dashing, toppings. It prevents carbonation. It makes walls “self-cleaning”. It prevents spalling due to ice. It makes maintenance and cleaning easier. It allows materials to breathe. It is preventative and remedial. It is colourless. The treated base can be painted.

An object of the invention is that the product is referred to as fungistatic. The term “fungistatic” means that it guarantees temporary protection against blue-stain fungi in freshly sawn wood. In order to be effective, the treatment must be carried out within a period of 24 hours after the sawing. All machining is to be banned following treatment.

An object of the invention is that the product is likewise a scaler rust converter and removes at least 60% of the rust on any metallic element.

An object of the invention is to have a main action: fire retardant and/or wood hardener saturator and/or anti-termite insecticide fungicide treatment and/or water-repellent and/or fungistatic agent and/or anti-corrosive, as well as a secondary action that is combined particularly in the applications: fire retardant and/or wood hardener saturator and/or anti-termite insecticide fungicide treatment and/or water-repellent and/or fungistatic and/or anti-corrosive.

An object of the invention is to propose a method for the treatment of wood that is effective in the long-term.

An object of the invention is to propose an economical method for the treatment of wood that is economical.

An object of the invention is to propose a method and associated treatment that is not dangerous either to the health of the processor or to that of the user.

An object of the invention is to propose a method of treatment associated with the treatment product. The method of treatment may be implemented using a specific machine by multi-micro injection.

An object of the invention is to propose a product that incorporates an anti-UV agent to protect the wood from the effects of sunlight, which may contribute to ageing, fading or dimensional changes due to the sun's heat.

### Dual Fixing/Active Agent Product by Combining Borate/Silicate

In a principal aspect, the invention proposes combining an active agent, which is borate, with a fixing agent, which is silicate. The invention thereby proposes, more particularly, two agent/fixing pairings, which are the potassium borate/potassium silicate pairing and the sodium borate/sodium silicate pairing. In the remaining text, the use of the term silicate/borate pairing will also be taken to mean the potassium borate/potassium silicate pairing and/or the sodium borate/sodium silicate pairing. The function of the borate is that of an active agent that rebuffs attacks by wood-destroying agents. The function of the silicate is that of a fixing agent that becomes fixed to the wood and enables it to resist fading, ageing and exposure to sunlight.

### Combined Action of the Borate/Silicate Pairing

The product is produced by mixing potassium borate powder/potassium silicate or sodium borate/sodium silicate in water. The mixture is then applied to wood. The combined action of the silicate/borate pairing is unknown when used as a wood treatment. Its action is combined, because the mixture quickly exhibits a pasty appearance, sticking with aggregation, which seems from the outset unsuitable for treatment by dipping or by brush application.

### Addition of an Adjuvant

In a particular form, the product contains an adjuvant that is a plagioclase, a basalt and pyroxene powder.

The powder is produced from crushed pieces, sand and powder. The crushing size is preferably executed in the following dimensions: fibre length 2 mm, fibre diameter 9 microns.

### Particular Mixing Proportion

In the exterior protection application described, a particular mixture is recommended that has the unique feature of adapting to all the functions described above.

The invention preferably proposes a dose of 4.55% disodium octoboratetetrahydrate paired with a dose of 0.75% sodium or potassium silicates. Plagioclase adjuvant, basalt and pyroxene powder content 0.005%.

### Mixture Proportion Range

In the interior protection application described, a particular mixture is recommended that has the unique feature of adapting to all the functions described above.

The invention preferably proposes a dose included between 1% and 8.75 disodium octoboratetetrahydrate combined with a dose of 0.75% to 8.75% sodium or potassium silicate. Plagioclase, basalt and pyroxene powder adjuvant content 0.005%.

### Protection from Sunlight

Zinc oxide or titanium oxide is added to the product in a proportion of 0.1%, which gives an anti-UV character that will confer protection against the harmful effects of sunlight.

### Application on Wood

The invention is a hydro-dispersible liquid preparation. It is highly recommended that the preparation is agitated in a closed can prior to application. Different application techniques are permitted: autoclave, diffusion dipping, tunnel coating, spraying, spray gun injection, painting to saturation point. Application method: painting or spraying with a minimum of two coats or more when the anticipated quantity is not reached. At 6 to 24 hour intervals, depending on the atmospheric humidity. Surface treatment of all visible parts to saturation point. The wood, fibres or materials must be bare, clean, dry and in good order. Stir well before use. Apply using a brush, roller or low-pressure spraying machine. Leave to penetrate for 30 minutes. Wipe away any surplus oil using a clean cloth. For greater protection, a second coat will be applied 12 hours after the first. For all species of wood, all bases: terraces, cladding, fences, garden furniture, pergolas, duckboard, furniture (including exotic wood). Provides deep nourishment. Protects against UV and weathering. Does not peel off. Does not form a film. Compatible with preliminary insecticide/fungicide treatment.

### Particular Fungistatic Application to Wood

It is recommended that maximum drying of the wood following treatment should be promoted, in order to take the moisture content of the wood below 22%. This threshold is reached by simple air drying, if the surfaces are all properly ventilated. Good ventilation is indispensible in order to achieve a satisfactory result. Setting time: minimum 4 hours in shelter. It is recommended that the treated wood is stored out of bad weather until it reaches its in-service moisture content.

### Particular Application to Other Porous Materials

Water-repellent on materials with a porous structure, cellular wood structures, hollow fibres, vegetable fibres including: fibres from seed hairs (cotton capoc), Liberian fibres extracted from plant stems (linen, hemp, jute, ramie); hard fibres extracted from leaves (sisal), trunks (abaca), fruit husks (coconut), animal fibres that come from hair, such as animal fleece and secretions, such as silk. Within the fibre, the cellulose chains are joined in micro-fibrils that aggregate to form fibrils on several layers. The product strengthens against humidity, improves heat performance (with fire-resistance of over 200° to 1200°), organises the cellulose fibrils, increasing overall resistance. It increases dimensional stability and improves the anti-ageing properties by more than 10 years.

Only apply to naturally porous materials: bricks, unfinished or coloured concrete, concrete slabs, gritted flags, concrete paving blocks, interlocking paving blocks, levellers, industrial floors, parking spaces, cellular concrete. Not suitable for blue stone and floor tiles. NB: A floor is referred to as porous if water poured onto it penetrates within two minutes.

### Particular Application: Façade, Tile, Wall, Rust

Method of application: painting or spraying minimum one coat. Surface treatment of all visible parts to saturation point. Prior to application, the surfaces being treated will be brushed and any grease marks, foam, markings removed. Stir before use. Apply the product to a dry base using a small or large brush or a spraying machine: 1 litre=3 to 5 m². The materials become impermeable instantly. The application must therefore be effected in a single coverage, particularly on materials that are not readily absorbent. Period required without rain following the end of treatment: minimum 6 hours.

Mineralising: It hardens materials and makes them less friable. Water-repellent: It prevents water penetration and makes materials less porous. It increases base resistance and slows down ageing. It provides deep penetration. Suitable for use on new and old materials. It eliminates chalking of coatings, pebble-dashing, toppings. It stops carbonation. It makes walls “self-cleaning”. It prevents spalling due to ice. It makes maintenance and cleaning easier. It allows materials to breath. It is colourless. The treated base can be painted.

### Concentration

| | INTERIOR | INTERIOR | EXTERIOR | EXTERIOR |
|---|---|---|---|---|
| FIRE RETARDANT | REMEDIAL | PREVENTATIVE | REMEDIAL | PREVENTATIVE |
| AVERAGE M2 PER | ±3 m² | ±5 m² | ±3 m² | ±5 m² |
| LITRE CONSUMED | | | | |
| Number of kilos of | 0.1105 KG | 0.1105 KG | 0.2210 KG | 0.2210 KG |
| concentrate per litre | | | | |
| SATURATOR | INTERIOR | INTERIOR | EXTERIOR | EXTERIOR |
| HARDENER | REMEDIAL | PREVENTATIVE | REMEDIAL | PREVENTATIVE |
| AVERAGE M2 PER | ±5 m² | ±10 m² | ±3 m² | ±7 m² |
| LITRE CONSUMED | | | | |
| Number of kilos of | 0.0638 KG | 0.0638 KG | 0.1280 KG | 0.1275 KG |
| concentrate per litre | | | | |
| FUNGICIDE | INTERIOR | INTERIOR | EXTERIOR | EXTERIOR |
| TREATMENT | REMEDIAL | PREVENTATIVE | REMEDIAL | PREVENTATIVE |
| AVERAGE M2 PER | ±5 m² | ±10 m² | ±3 m² | ±7 m² |
| LITRE CONSUMED | | | | |
| Number of kilos of | 0.0455 KG | 0.0458 KG | 0.0623 KG | 0.0495 KG |
| concentrate per litre | | | | |
| WATER | INTERIOR | INTERIOR | EXTERIOR | EXTERIOR |
| REPELLENT | REMEDIAL | PREVENTATIVE | REMEDIAL | PREVENTATIVE |
| AVERAGE M2 PER | ±3 m² | ±5 m² | ±3 m² | ±5 m² |
| LITRE CONSUMED | | | | |
| Number of kilos of | 0.0514 KG | 0.0515KG | 0.0750 KG | 0.0712 KG |
| concentrate per litre | | | | |

| | EXTERIOR |
|---|---|
| FUNGISTATIC | PREVENTATIVE |
| AVERAGE M2 PER | 20 L/M3 |
| LITRE CONSUMED | |
| Number of kilos of | 0.0314 KG |
| concentrate per litre | |
| FLOOR, FA [symbol] ADE, | EXTERIOR |
| WALL | PREVENTATIVE |
| AVERAGE M2 PER | 10 to 20 L/M3 |
| LITRE CONSUMED | |
| Number of kilos of | 0.0412 KG |
| concentrate per litre | |
| RUST | |
| PREVENTATIVE | EXTERIOR |
| AVERAGE M2 PER | 0.5 to 1.5 L/M3 |
| LITRE CONSUMED | |
| Number of kilos of | 0.0220 KG |
| concentrate per litre | |

| | BOTTOM | | CLEANING | APPLICATION |
|---|---|---|---|---|
| COVERAGE | DRYING | MATERIAL | OF TOOLS | TEMPERATURE |
| Preventative: | 24/48 hrs | Brush, flow coating | In water | +5° C. to +45° C. |
| 1.0 m2/l | | with garden spray | immediately | |
| Remedial: 1.5 m2/l | | gun, pressure | after use | |
| | | injection, dipping | | |
| | | and autoclave | | |

### Particular Application: Method of Treatment by Multi-Micro Injection

This pairing evidently exhibits a major defect, which is, however, corrected by the method according to the invention. In fact, the borate/silicate pairing amalgamates quite quickly and has a tendency to harden. Application by brush or dipping is therefore difficult and requires great skill and dexterity.

The invention succeeds in applying the product to the core of the wood by implementing multi-micro injection of the product through needles or similar devices. The product will then harden in the core of the wood. The active agents remain fixed there. The hardening of the product in the core of the wood and on the wood's surface thereby changes the mechanical characteristics of the treated wood, which gains in resistance. The modified wood likewise gains in the fire propagation time through an oxygen smothering effect in the wood. The borate/silicate pairing will therefore act simultaneously in the core of the wood, but likewise in the micro-injection holes, which will be filled with the product, which will harden inside said holes. The wood will therefore have a smooth appearance.

### Mechanical Resistance Change Action in the Core of the Wood

When examined under a microscope, a thin section to the point of being transparent of a young trunk reveals the existence of cells, small vessels filled with a constantly evolving viscous material, the protoplasm or cytoplasm in which a more condensed nucleus is discernible. The cells are identical to begin with. Their wall is formed from cellulose. There is an intercellular layer containing gummy products between the membranes of contiguous cells. A cell reproduces by division. Dead cells are those that no longer contain any protoplasm. The cells are modified to perform given functions. A group of specialised cells performing the same function is called tissue. Certain cells are thereby greatly lengthened and form vessels or ducts (vascular tissue) through the disappearance of dividing walls.

More particularly, the combined action of the borate/silicate pairing, which penetrates the structure of the wood and reinforces the cell-to-cell links within the wood and therefore acts particularly on the intercellular layer. This brings about a change in the pectin substances with reinforcement of the cell-to-cell links, this being in three dimensions. There is a transformation of the secondary wall and notably of the cellulose by transformation of the polysaccharides and plugging of the vessels in the sapwood zone, reproducing heartwood formation. The sodium within the wood will be irreversibly transformed to reinforce cell-to-cell contacts and will therefore harden the wood and reinforce it when the fire starts.

The present invention therefore relates to a method for the treatment of wood, particularly intended for exterior wood for preventative and remedial protection against wood-destroying agents and against fire propagation, characterised in that it involves the application of a mixture with a dose of 4.55 disodium octoboratetetrahydrate combined with a dose of 0.75% sodium or potassium silicate, a plagioclase adjuvant, basalt and pyroxene powder content 0.005%, sunlight protection through zinc oxide or titanium oxide in a proportion of 0.1%.

The present invention therefore relates to a hydro-dispersible liquid preparation for the treatment of exterior wood for preventative and remedial protection against wood-destroying agents and against fire propagation, characterised in that it involves the application of a mixture with a dose of 4.55% disodium octoboratetetrahydrate combined with a dose of 0.75% sodium or potassium silicate, a plagioclase adjuvant, basalt and pyroxene powder content 0.005%, sunlight protection through zinc or titanium oxide in a proportion of 0.1%.

The present invention therefore relates to a method of treatment, characterised in that it is applied to porous construction materials, facades and walls.

The present invention therefore relates to a hydro-dispersible liquid preparation, characterised in that it is applied to porous construction materials, facades and walls.

The present invention therefore relates to a hydro-dispersible liquid preparation, characterised in that it is applied in fungistatic applications with a minimum fixing time of 4 hours in shelter, the wood is treated out of bad weather until it reaches its in-service moisture content.

The present invention therefore relates to a hydro-dispersible liquid preparation for the treatment of interior wood for preventative and remedial protection against wood-destroying agents and against fire propagation, characterised in that it includes the application of a mixture with a dose included between 1% and 8.75% disodium octoboratetetrahydrate combined with a dose of 0.75% to 8.75% sodium or potassium silicate, plagioclase adjuvant, basalt and pyroxene powder content 0.005%, sunlight protection through zinc oxide or titanium oxide in a proportion of 0.1%.

It is clear that numerous variants possibly capable of being combined can be provided without stepping beyond the framework of the invention as it is defined below.

1- Method for the treatment of wood particularly intended for exterior wood for preventative and remedial protection against wood-destroying agents and against fire propagation, characterised in that it involves the application of a mixture with a dose of 4.55% disodium octoboratetetrahydrate combined with a dose of 0.75% sodium or potassium silicate, a plagioclase adjuvant, basalt and pyroxene powder content 0.005%, sunlight protection through zinc oxide or titanium oxide in a proportion of 0.1%.

2- Hydro-dispersible liquid preparation for the treatment of exterior wood for preventative and remedial protection against wood-destroying agents and against fire propagation, characterised in that it involves the application of a mixture with a dose of 4.55% disodium octoboratetetrahydrate combined with a dose of 0.75% sodium or potassium silicate, a plagioclase adjuvant, basalt and pyroxene powder content 0.005%, sunlight protection through zinc oxide or titanium oxide in a proportion of 0.1%.

3- The method for treatment according to claim 1, characterised in that it is applied to porous construction materials, facades and walls.

4- The hydro-dispersible liquid preparation according to claim 2, characterised in that it is applied to porous construction materials, facades and walls.

5- The hydro-dispersible liquid preparation according to claim 2, characterised in that it is applied in fungistatic applications with a minimum fixing time of 4 hours in shelter, the wood is treated out of bad weather until it reaches its in-service moisture content.

6- The hydro-dispersible liquid preparation for the treatment of interior wood for preventative and remedial protection against wood-destroying agents and against fire propagation, characterised in that it involves the application of a mixture with a dose included between 1% and 8.75% disodium octoboratetetrahydrate combined with a dose of 0.75% to 8.75% sodium or potassium silicate, plagioclase adjuvant, basalt and pyroxene powder content 0.005%.
